(19) United States
(12) Patent Application Publication
(10) Pub. No.: US 2001/0015809 A1
(43) Pub. Date: Aug. 23, 2001

(54) HOMODYNE INTERFEROMETER USING PHOTOREFRACTIVE POLYMER COMPOSITE AND METHOD OF SENSING MATERIAL

(76) Inventors: MARVIN B. KLEIN, PACIFIC PALISADES, CA (US); G. DAVID BACHER, SANTA ANA, CA (US); DANIEL WRIGHT, LA JOLLA, CA (US); W. E. MOERNER, LOS ALTOS, CA (US); ANDERS GRUNNET-JEPSEN, EUGENE, OR (US)

Correspondence Address: THOMAS A TURNER, 11377 WEST OLYMPIC BOULEVARD, LOS ANGELES, CA, 90064

(21) Appl. No.: 09/268,424

(22) Filed: Mar. 12, 1999

Related U.S. Application Data
(63) Continuation-in-part of application No. 08/995,655, filed on Dec. 22, 1997, now Pat. No. 5,900,935.

(51) Int. Cl. G01B 11/02

(52) U.S. Cl. 356/502

(57) ABSTRACT

Faults, dimensions and other characteristics of a material or structure are sensed by a coherent beam's reflection from the material during ultrasonic or very fast vibration. The reflected beam acquires a phase substantially different from its original phase and from the phase of a reference beam split from the common source beam. The reflected beam and the reference beam are superimposed by diffraction in a photorefractive polymer composite adaptive holographic beamsplitter, and the superimposed beams are detected by a photodetector capable of detecting small interference changes from ultrasonic surface displacements or perturbations. An apparatus and method defining an improved homodyne interferometer for performing the method is described.

### BACKGROUND OF THE INVENTION

1. Field of the Invention

The present invention relates to the art of detecting faults and other characteristics in materials, and more particularly to methods and apparatus for detecting faults and other characteristics in ultrasonically vibrated test material using homodyne interferometers.

2. Background of the Invention

Laser ultrasonic receivers based on optical homodyne interferometers have been investigated for some years. Such receivers have been used and proposed for the examination of materials, such as, for example, investigating transient body transformations, inspecting materials such as metals and ceramics at high temperatures for process and quality control, detecting flaws as soon as they are created, measuring production parameters such as thickness and temperature, and determining microstructural properties on-line such as grain size, porosity and the like. In early research, it was realized that a homodyne interferometer could not operate effectively with the speckled beams that result from reflecting from rough surfaces. Furthermore, such early homodyne interferometers could not compensate for aberrations in the signal beam wavefront resulting from slow, dynamic environmental disturbances.

Time-delay or self-referencing interferometers have been developed, such as the confocal Fabry-Perot which allow the processing of light scattered from rough surfaces with a large field of view. Usually, a phase modulated signal beam is derived from a probe beam scattered or reflected from a vibrating test surface. This beam is demodulated by the slope of the transfer function, which is the transmission versus frequency, of the confocal Fabry-Perot. As a self-referencing or time-delay interferometer, the confocal Fabry-Perot has the ability to process speckled beams from imperfect surfaces. In addition, the particular mirror curvature of the confocal Fabry-Perot provides a much larger field of view than a Fabry-Perot with flat mirrors. The operation of the confocal Fabry-Perot is described in, for example, U.S. Pat. No. 4,659,224. However, the confocal Fabry-Perot requires stabilization of the interferometer length to a fraction of an optical wavelength, thereby adding complexity and cost to the receiver.

The transmitted signal from a confocal Fabry-Perot is proportional to the amplitude of the Doppler shift of the signal beam frequency upon scattering from a vibrating surface. For constant displacement, the Doppler shift decreases with frequency. As a result, the confocal Fabry-Perot does not work well at low ultrasonic frequencies below approximately one megahertz (1 MHz). Solutions to such problems and limitations have been proposed. See, for example, U.S. Pat. No. 5,131,748 to Monchalin and Ing, where the beam that probes the vibrating surface is caused to interfere inside a photorefractive material with a reference or pump beam, resulting in these two beams diffracting in each other's direction with a common path and a common wavefront. An electrical signal dependent on phase excursions or perturbations in the reflected or scattered beam produced by the surface vibration is then obtained by a photodetector in one of these paths. For the correct static phase difference between the wavefronts of the two interfering beams, the electrical signal is linearly proportional to the phase excursion and thus to the surface deflection. The photorefractive material acts in effect as a real-time hologram providing an exact overlap of the reference beam with the signal beam for later coherent detection and it compensates for low frequency dynamic environmental distortions in the signal wavefront. However, most materials used previously do not have both a fast response time and a large diffraction efficiency which is desired for uses in many applications. Such systems also do not operate well at low signal beam light levels produced when scattering from a rough surface, as is typical for many workpieces.

It is still desired further to provide a homodyne interferometer that will have the capability of processing speckled returns from the workpiece with a high field-of-view or étendue. It is desired yet further to obtain an homodyne interferometer having an adaptive holographic beamsplitter which can be fabricated more easily, with greater flexibility and is capable of being fabricated more rapidly and at lower cost. It is a desired object, further, to provide an homodyne interferometer where large coefficients of coupling can be selected and obtained by the application of practical values of electric fields applied across an adaptive beam splitter. It is yet further desired to provide an homodyne interferometer in which the application of a controlled electric field across the adaptive beamsplitter alters and controls the spatial phase of the index grating in the beam splitting element to allow coherent detection in the linear regime. It is still further desired to provide an homodyne interferometer having an adaptive beamsplitter element in which the absorption under typical operating conditions can be set to a low value. It yet still further desired to provide an homodyne interferometer having an adaptive beamsplitter which can be easily processed into a variety of shapes and forms.

### SUMMARY

In brief, in accordance with one aspect of the present invention, a coherent, polarized light beam is split, one of the beams being used as a reference beam. The other beam is reflected or scattered from a surface of the material which is vibrated by an ultrasonic frequency source. The reflected beam has its phase shifted in proportion to the surface deflection or perturbation and is impinged on the surface of a photorefractive polymer composite-adaptive holographic beamsplitter. The reference beam is also impinged onto the surface of the polymer composite adaptive holographic beamsplitter to create effectively an interference of the two beams, resulting in a refractive index grating. This grating causes the beams to diffract into each other, so that the original beam and the diffracted beam are co-propagating and have identical wavefronts. The beam with superposed wavefronts is received by a photodetector which senses the high frequency dynamic phase difference between the two beams and produces a signal representative of the perturbations of the vibrating test surface.

Using the photorefractive polymer composite, the resulting homodyne interferometer has a surface displacement sensitivity which is close to the ideal value. Response times on the order of approximately one millisecond have been measured, thus allowing the receiver to compensate for wavefront disturbances with bandwidths up to approximately one kilohertz (kHz). In addition, this performance can be achieved for values of device absorption as low as ten percent (10%). The polymer composite material adaptive beamsplitter is more versatile in design capabilities, and can be fabricated in less than a day.

Other novel features which are believed to be characteristic of the invention, both as to organization and methods of operation, together with further objects and advantages thereof, will be better understood from the following description in which preferred embodiments of the invention are described by way of example.

### DESCRIPTION OF THE DRAWINGS

FIG. 1 is a schematic view showing diagramatically the paths of the signal and reference beams from generation to detection;

FIG. 2 is a schematic view of beam paths through the holographic element of FIG. 1 showing the beam paths in component detail;

FIG. 3 is a schematic perspective view of a multiple quantum well beamsplitter showing the interference of the two beams;

FIG. 4 is a schematic top or plan view of the multiple quantum well beamsplitter of FIG. 3;

FIG. 5 is a cross-sectional view showing the layers of a multiple quantum well structure of the completed holographic element of the preferred embodiment of the present invention taken along the view of line 5-5 of FIG. 3;

FIG. 6 is a cross-sectional view showing the layers of the multiple quantum well structure of the preferred embodiment of the present invention as shown in FIG. 5 after film growth and before further fabrication;

FIG. 7 is an exploded cross-sectional view taken along line 7-7 of FIG. 3 showing schematically the intensity and diffraction grating patterns within the holographic element;

FIG. 8 is a schematic perspective of a composite polymer beamsplitter showing the interference of two beams;

FIG. 9 is a schematic top or plan view of the composite polymer beamsplitter of FIG. 15;

FIG. 10 is a detailed cross sectional blow-up of the holographic element of FIGS. 8 and 9 showing the development of gratings and the passage of light beams;

FIG. 11 is a plot showing the measured coupling coefficients as a function of applied electric field for p-polarized light with an inset showing the measured absorption coefficient α as a function of wavelength λ;

FIG. 12 is a plot showing the relative surface displacement sensitivity as a function of the imaginary coupling strength γ_{I}L, for various values of α/γ_{I}, the ratio of the absorption coefficient to the imaginary part of the coupling coefficient; and,

FIG. 13 shows the transmitted ultrasonic signal and its echoes in a fused quartz mirror with a wideband transducer bonded to its rear surface.

### DESCRIPTION OF THE PREFERRED EMBODIMENT

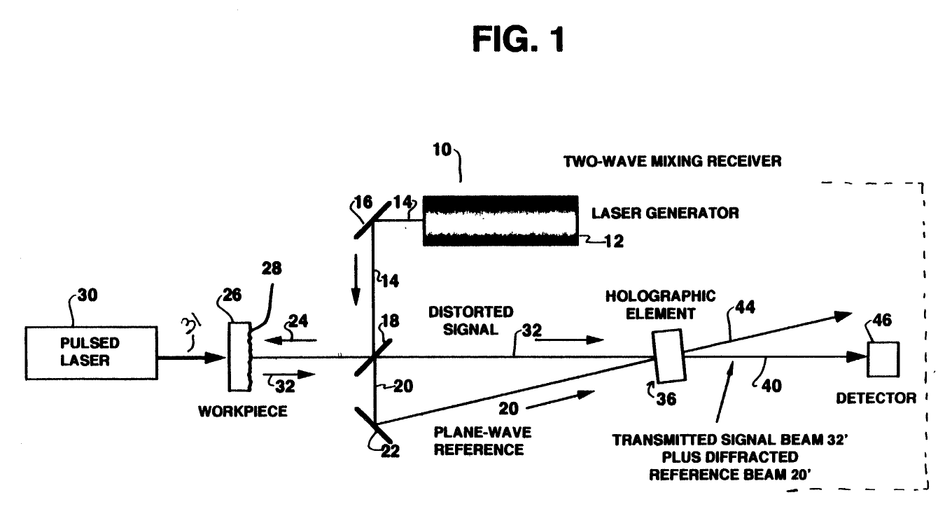

Referring initially to FIG. 1 of the accompanying drawings where reference numerals correspond to like numerals used in this specification, the reference-beam interferometer two-wave mixing receiver 10 of the preferred embodiment includes a laser generator 12 which generates as its output a coherent light beam 14. The light beam 14 is directed in the direction of the adjacent arrow by mirror 16 to beamsplitter 18 which divides the beam 14 into a reference beam 20 passing through the splitter 18 and into a probe beam 24 directed toward the workpiece or material 26 to be examined. The reference beam 20 is directed by mirror 22 for superposition with the signal wave, as will be described in greater detail below. The probe beam 24 will be reflected or scattered from the normally rough surface 28 as the return signal beam 32 traveling back along its incident path.

The surface 28 of the workpiece is vibrated ultrasonically as a result of a pulsed laser 30. The pulsed laser 30 produces a momentary light beam 31 impinging the workpiece 26 to generate an ultrasonic wave that travels through the workpiece 26 to result in a vibration of the workpiece surface 28.

The vibration or displacement of the workpiece surface 28 will impart phase perturbations on the probe beam 24 when it is reflected back as the return signal beam 32. In addition, the rough surface of the workpiece 26 and turbulence in the optical beam path will cause spatial wavefront distortions on the return signal beam 32.

The distorted return signal beam 32 is guided toward the real-time holographic element 36. The return signal beam 32 is combined or superposed with the reference beam 20 in the holographic element 36, which results in two output beams 40, 44. The superposition of at least parts of the distorted return signal beam 32 and the reference beam 20 form, as the output, the beam 40, which is directed to the photodetector 46.

The difference in the cumulated path length of beam 20 and the path length of beams 24 and 32 between the beamsplitter 18 and the receiving surface of the holographic element 36 should be less than the coherence length of the laser generator 10.

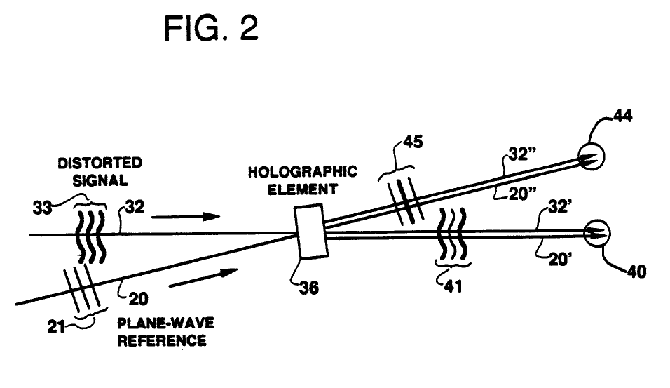

Referring to FIG. 2, the effect of the holographic element 36 on the incident beams 20, 32 is shown in greater detail. The reference beam 20 is partially diffracted as beam 20′ and superposed on the distorted beam 32 which is partially transmitted as beam 32′. The superposed components of the partially diffracted reference beam 20′ and the partially transmitted signal beam 32′ have identical paths and comprise the resultant beam 40 directed to the photodetector 46. The incident reference beam has planar wavefronts 21, while the incident distorted signal beam 32 has distorted wavefronts 33. The resultant beam 40 will have overlapped wavefronts 41 with the same distortion of wavefronts 33. The incident reference beam 20 is also partially transmitted through the holographic element 36 as component beam 20″, while the incident distorted beam 32 is partially diffracted by the element 36 as component beam 32″. The component beams 20″, 32″ have identical paths and comprise the resultant beam 44. The resultant beam 44 will have overlapped planar wavefronts 45.

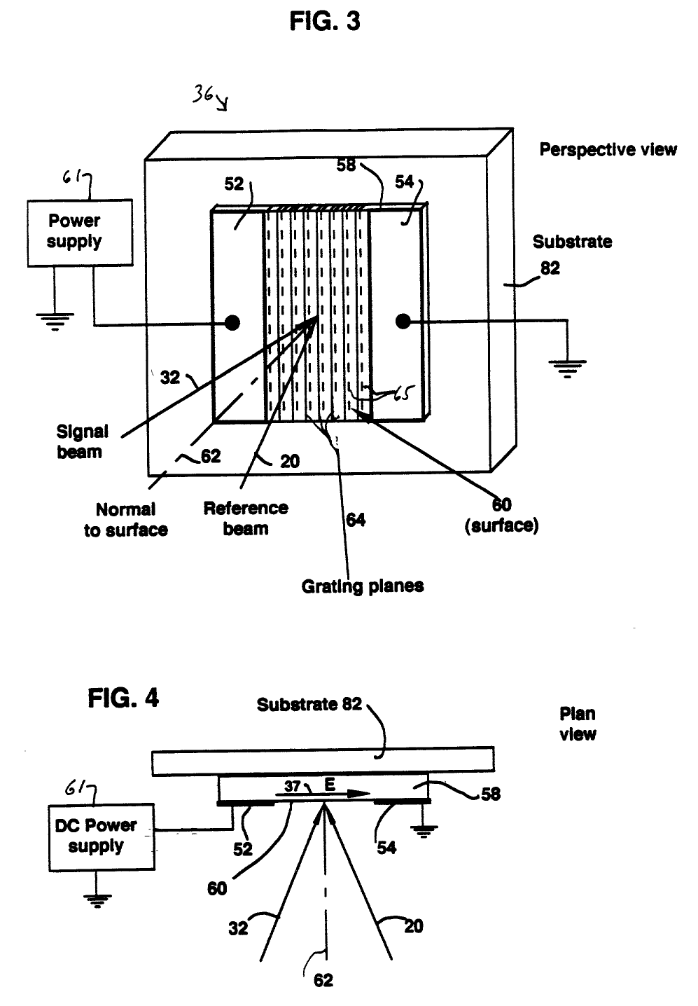

Referring to FIG. 3, a perspective view of the structure of the photorefractive, holographic adaptive beamsplitter element 36 as a multiple quantum well structure can be seen in greater detail. The element 36 consists of the semiconductor structure 58 with metal electrodes 52, 54 mounted on a supporting substrate 82 a few millimeters (mm) thick. The substrate 82 may be sapphire, glass or a pyrex material, as is commonly used. The semiconductor structure 58 has a first electrode 52 and a second electrode 54 at opposite ends of the incident surface 60, best seen in FIG. 4, which is a top or plan view of the holographic element 36 of FIG. 3. A potential field 37 is maintained across the structure 58 between the electrodes 52, 54 by a direct current power supply 61. Between the electrodes 52, 54 a portion of the semiconductor structure 58 is exposed to form the incident surface 60. The surface 60 of the semiconductor structure 58 receives the incident beams 20, 32. A centerline 62 indicating the line normal to the surface 60 is also shown.

The incidence of the two beams 20, 32 onto the surface 60 of the element 36, referring again to FIGS. 3, 4, results in the intensity grating planes 64, caused by the interfering beams. The intensity grating creates the diffracton grating, shown schematically by the evenly dashed lines, 65, in FIG. 3.

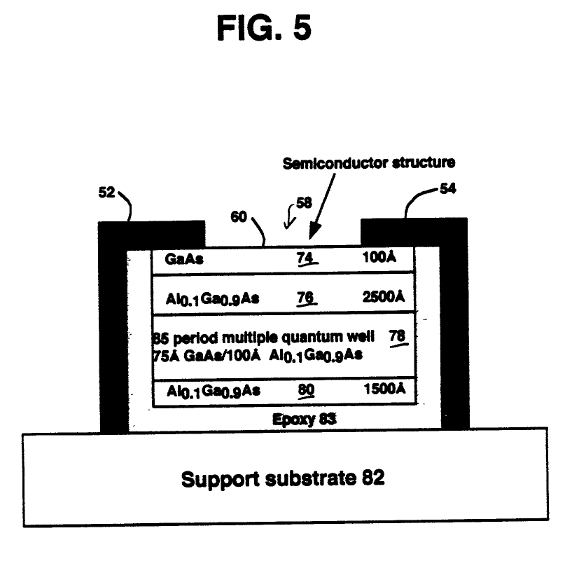

FIG. 5 shows a cross-sectional view of the holographic element 36 comprising the semiconductor structure 58, electrodes 52, 54 and supporting substrate 82. As seen in FIG. 5 the semiconductor structure 58 is supported on the substrate 82 using a transparent nonconductive epoxy 83. Specifically shown in FIG. 5 is the supporting substrate 82 and epoxy 83 supporting a first layer 80 consisting of 1500 Angstroms of 10% aluminum gallium arsenide (Al_{0.1}Ga_{0.9}As). The next layer 78 is the active photoconductive electro-optic layer and consists of an eighty-five period multiple quantum well structure consisting of alternating layers of 75 Angstrom thick gallium arsenide (GaAs) quantum wells and 100 Angstrom thick 10% Al_{0.1}Ga_{0.9}As barriers. The next layer 76 consists of 10% aluminum gallium arsenide (Al_{0.1}Ga_{0.9}As) of approximately 2500 Angstroms thickness. The next layer 74 consists of GaAs at approximately 100 Angstrom thickness. The GaAs layer 74 now forms the top layer of the semiconductor structure 58 and comprises the surface 60 facing the incoming wavefronts 20, 32 (best seen in FIGS. 3, 4).

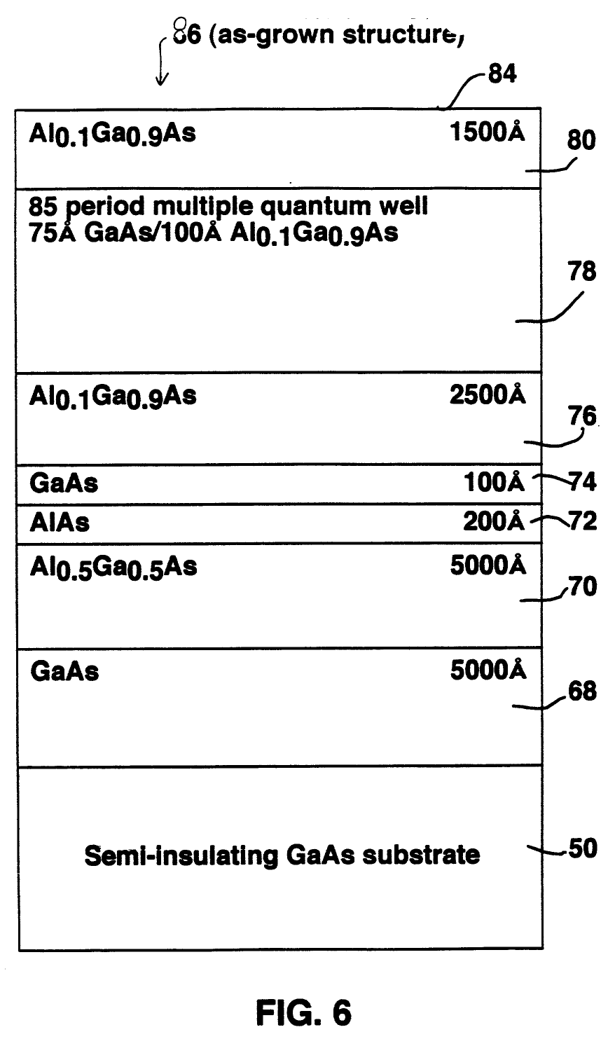

The method of fabricating the semiconductor structure 58 comprises an epitaxial growth of multiple layers by molecular beam epitaxy, best illustrated in FIG. 6. Beginning with an epitaxial-ready gallium arsenide substrate 50 which is approximately 0.5 millimeter (mm) thick, a first layer 68 of gallium arsenide (GaAs) approximately 5000 Angstroms thick is grown. This layer 68 is useful to planarize the surface to ensure good epitaxial crystal growth. Next, a second layer 70 of 50% aluminum gallium arsenide (Al_{0.5}Ga_{0.5}As) is grown approximately for 5000 Angstroms. This layer is used as an etch stop layer during wet chemical etching (19 parts hydrogen peroxide and 1 part ammonium hydroxide) in device fabrication. A third layer 72 of aluminum arsenide (AlAs) is then grown for approximately 200 Angstroms. This layer 72 serves as a lift-off layer during device fabrication which is etched off during a 50% hydrofluoric acid etch in order to form an optically flat surface.

Next a fourth layer 74 of GaAs is grown for approximately 100 Angstroms. This layer 74 plays a role in the fabrication procedure of the final device, which is the stop etch layer for the 50% hydrofluoric acid etch and also acts as a passivation layer of the final device, the photorefractive multiple quantum well, real time holographic element 36. A fifth layer 76 of 10% aluminum gallium arsenide (Al_{0.1}Ga_{0.9}As) of approximately 2500 Angstroms thickness is grown next. This spacer layer 76 is used to control the thickness of the device to set the preferred Fabry-Perot condition, to enhance the diffractive performance of the holographic element 36 without changing the optical properties of the active layer 78. A sixth layer 78 comprises an eighty-five period multiple quantum well structure consisting of 75 Angstrom thick GaAs quantum wells and 100 Angstrom thick 10% aluminum gallium arsenide (Al_{0.1}Ga_{0.9}As) barriers. This multiple quantum well layer 78 forms the active photoconductive electro-optic layer of the holographic element 36. A seventh layer 80 is grown to approximately 1500 Angstroms consisting of 10% aluminum gallium arsenide (Al_{0.1}Ga_{0.9}As).

Characteristics of the multiple quantum well (MQW) can be modified by varying the thickness and/or material composition of the various layers as desired.

The as-grown structure 86 is proton implanted from the top surface 84 of layer 80 at different energies and doses to control the number and profile of defects created in the active electro-optic layer 78. The structure 86 is then cleaved into approximately 2 mm×2 mm squares, and mounted at its top surface 84 as seen in FIG. 5, that is the end having the layer consisting of Al_{0.1}Ga_{0.9}As to a supporting substrate 82 (FIG. 4) using a transparent nonconductive epoxy 83.

The GaAs substrate 50 is lapped using fine alumina grit to a thickness of 100 microns. The structure 86 is then subjected to a wet chemical etch consisting of 19 parts hydrogen peroxide and 1 part ammonium hydroxide. This etch removes the remaining GaAs substrate 50 and the 5000 Angstrom GaAs epilayer 68. The etch stops somewhere in the etch stop layer 70 of Al_{0.5}Ga_{0.5}As. The structure 86 is then subjected to a 50% hydrofluoric acid solution which removes the remaining Al_{0.5}Ga_{0.5}As layer 70 and the AlAs layer 72, resulting in an almost optically flat surface of layer 74, which becomes the surface 60. The electrodes 52, 54 are then evaporated on the surface 60 (best seen in FIGS. 3, 4, 5) with an interelectrode spacing of approximately 1 mm.

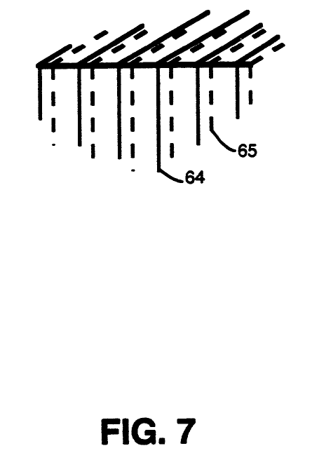

FIG. 7 shows in an exploded view the patterns of the intensity grating 64 and the complex diffraction grating 65 in the structure 58. The intensity grating is shown schematically by the solid lines 64. The diffraction grating is shown by the dashed lines 65.

In operation, the photorefractive multiple quantum well, real-time holographic element 36 acts as an adaptive beamsplitter matching the wavefronts of the return signal 32 and the reference beam 20. The return signal 32 acquires a phase perturbation relative to the phase of the reference beam 20 caused by the ultrasonic vibration of the surface 28.

When the reference beam 20 and the return signal beam 32 interfere in the photorefractive multiple quantum well holographic element 36, they produce a complex refractive index and absorption grating 65 that records the spatial phase profile of the return signal beam 32. This holographic recording and subsequent readout process yields an output beam 40 that is a composite or superposition of the partially transmitted signal beam 32′ and the partially diffracted reference beam 20′. The holographic combination of these beams insures that they have precisely overlapped wavefronts.

The separate beams 20′, 32′ that contribute to the composite beam 40 have a static relative longitudinal phase difference apart from the phase perturbation acquired by the return signal 32 from the ultrasonic vibration of the workpiece surface 28. The static relative longitudinal phase depends on the design of the holographic element 36, on the applied electric field (E) 37 and on the chosen wavelength on the beam 14 from light source 12. These factors determine a spatial shift of the complex grating 65 in the element 36 relative to the optical interference pattern 64 created by the return beam 32 and the reference beam 20. This spatial shift contributes to the static relative longitudinal phase of the separate beams 20′, 32′ that contribute to the composite beam 40. Specifically, this static relative longitudinal phase is equal to the photorefractive phase shift plus or minus the wavelength-dependent phase of the signal 20′ diffracted by the complex grating, plus or minus 90 degrees.

Optimally, the static relative longitudinal phase is adjusted in operation such that it is as close as possible to the 90 degree quadrature condition. However, good detection using the principles of this invention is achieved with shifts in the ranges of from 30 degrees to 150 degrees, and from 210 degrees to 330 degrees. In any case, no path-length stabilization is required to maintain this condition as with a conventional interferometer system.

One unique feature of the preferred embodiment of the present invention is the ability to produce the required value of the relative phase by adjusting the applied electric field 37 or by adjusting the wavelength of the laser beam 14.

The relative longitudinal phase for the superposed output beam 40 is independent of any wavefront changes on the input beams 20, 32 due to turbulence, vibrations and the like as long as the wavefront changes occur on a time scale that is slow relative to the grating buildup time. The grating buildup time, as used in this specification, is the time required for the amplitude of the refractive index and absorption gratings to reach a given fraction of its final steady-state value. The changes that occur very rapidly, such as the perturbations modulated on the return distorted signal beam 32 as a result of the ultrasonic vibrations of the workpiece surface 28, will be transferred to the output beam 40 and be detected by the detector 46. It has been found that a suitable detector 46 may be a Model 1801 provided by New Focus, Inc. of Santa Clara, Calif.

As described above, the homodyne interferometer constructed of the photorefractive quantum wells operates by combining two coherent laser beams consisting of the signal beam 32 and the reference beam 20. Their interference pattern 64 is converted into a complex diffraction grating 65 in the photorefractive quantum well layer 78. The diffraction grating 65 is composed of changes in both the refractive index and the absorption. The periodicity of the diffraction grating 65 matches the periodicity of the interference intensity pattern 64 generated by beams 32 and 20. However, the complex diffraction grating 65 is generally shifted relative to the intensity pattern 64. This spatial shift of the gratings is described in terms of the photorefractive phase shift φ₀.

A key parameter that allows different homodyne interferometers to be compared is the signal-to-noise ratio of the laser-based ultrasound device. The signal-to-noise ratio defines the smallest surface displacement that can be detected above the noise level for a defined detection bandwidth and for a defined power level on the detector.

For the embodiment of the homodyne interferometer described here, the signal is determined by a complex phase shift of the electromagnetic wave after traversing the thin semiconductor film. The complex phase shift is

$${δ}_{K} = \frac{2 π {n}_{K} ( λ ) L }{λcos {θ}^{′}} + i \frac{{α}_{K} ( λ ) L}{2 cos {θ}^{′}} \qquad ( 1 )$$

where λ is the wavelength, L is the thickness of the active layer 78, θ′ is the angle between the direction of propagation and the surface normal, η_{K} is the wavelength-dependent K-th Fourier coefficient of the refractive index grating and α_{K} is the K-th Fourier coefficient of the absorption grating in the device, where K=±1,0 are the grating vectors of interest in two-wave mixing.

This complex phase shift modulates the amplitude and phase of the reference wave 20 causing it to partially diffract in the direction of the signal beam 32. The copropagating partially diffracted wave 20′ and the partially transmitted signal beam 32′ together comprise the beam 40 that reaches the photodetector 46.

Homodyne detection occurs because there is a phase relationship between the partially diffracted reference beam 20′ and the partially transmitted signal beam 32′. The superposed beam 40 is given by

$${E}_{40} = {E}_{32} exp ( i {δ}_{o} ) + \frac{1}{2} {δ}_{1} {E}_{20} exp i ( {δ}_{o} + {φ}_{o} + \frac{4 π}{λ} d ( t ) + \frac{π}{2} ) , \qquad ( 2 )$$

where E₄₀ is the amplitude of the combined beam after leaving the holographic element 36, E₃₂ is the amplitude of the signal beam incident on the holographic element 36, E₂₀ is the amplitude of the reference beam incident on the holographic element 36, φ₀ is the photorefractive phase shift defined by the spatial shift of the optical gratings relative to the intensity pattern, and d(t) is the time-dependent surface displacement of the workpiece surface 28.

The combined beam 40 can be expressed as

$${E}_{40} = exp ( i {δ}_{o} ) [ {E}_{32} + \vert γ \vert {E}_{20} exp i ( {φ}_{o} + β ( λ ) + \frac{4 π}{λ} d ( t ) + \frac{π}{2} ] \qquad ( 3 )$$

where

$$β ( λ ) = {tan}^{- 1} [ \frac{λ}{4 π} \frac{{α}_{1} ( λ )}{{n}_{1} ( λ )} ] \qquad ( 4 )$$

is a phase associated with the relative contributions of the index and absorption gratings to the beam 40, and

$$\vert γ ( λ ) \vert = \sqrt{{( \frac{π {n}_{1} ( λ ) L}{λcos {θ}^{′}} )}^{2} + {( \frac{{α}_{1} ( λ ) L}{4 cos {θ}^{′}} )}^{2}} \qquad ( 5 )$$

is the magnitude of the coupling efficiency between the two beams 20 and 32.

The optimal homodyne detection occurs when the total relative longitudinal phase of partially transmitted signal beam 32′ relative to the partially diffracted reference beam 20′ is equal to π/2. From Equation(3) this condition is satisfied when

φ₀=−β(λ) (6)

This condition satisfies the requirements for linear detection of the surface displacement d(t).

The photorefractive phase shift φ₀ of the photorefractive quantum wells is a function of the applied electric field, the fringe spacing, the wavelength or the defect density. The unique feature of the photorefractive quantum wells is that condition of Equation (6) can always be satisfied for any photorefractive phase shift φ₀ by tuning the wavelength λ around the excitonic resonances.

Using the above relations we can write an expression for the total power in the combined beam 40 incident on the detector:

$${P}_{40} = [ {\vert {E}_{32} \vert}^{2} + {\vert γ \vert}^{2} {\vert {E}_{20} \vert}^{2} + 2 \vert γ \vert {E}_{20} {E}_{32} sin \frac{4 π}{λ} d ( t ) ] exp ( - {α}_{o} L ) , \qquad ( 7 )$$

where α₀ is the static value of the absorption coefficient. If we assume that |γ|<<1 and write d(t)=d₀cos(ωt), then

$${P}_{40} = [ {\vert {E}_{32} \vert}^{2} + 2 \vert γ \vert {E}_{20} {E}_{32} \frac{4 π}{λ} {d}_{o} cos ( ω t ) ] exp ( - {a}_{o} L ) . \qquad ( 8 )$$

As expected from the principles of coherent detection, the introduction of a sinusoidal phase modulation produces an amplitude-modulated signal at the photodetector.

Using similar concepts, the signal-to-noise ratio (S/N) is given by

$$\frac{S}{N} = \frac{η ( Δ {P}_{40} ) / hv}{\sqrt{\frac{η {P}_{32} {ⅇ}^{- {α}_{o} L}}{hv} ( Δ f )}} , \qquad ( 9 )$$

where η is the quantum efficiency, ΔP₄₀ is the magnitude of the time-varying portion of the transmitted power [given by the second term in Equations (7) and (8)], hv is the photon energy, and Δf is the detection bandwidth. Substituting for ΔP₄₀, we find

$$\frac{S}{N} = \sqrt{\frac{η {P}_{20} }{hv ( Δ f )}} {ⅇ}^{- \frac{{α}_{o} L}{2}} \vert γ ( λ ) \vert \frac{4 π}{λ} d ( t ) \qquad ( 10 )$$

Another commonly used parameter used to characterize a laser ultrasonic receiver is the minimum detectable surface displacement amplitude dₘᵢₙ, expressed in Angstroms times the square root of W/Hz. This parameter corresponds to the minimum detectable displacement (for which S/N=1) for 1 watt (W) incident power and 1 Hertz (Hz) detection bandwidth. With this definition, the minimum detectable surface displacement amplitude can be written as

$${d}_{min} ( λ ) = \frac{λ}{4 π} \sqrt{\frac{hv}{η}} \frac{1}{\vert γ ( λ ) \vert} exp ( \frac{{a}_{o} L}{2} ) \qquad ( 11 )$$

where the minimum detectable displacement (dₘᵢₙ) is a function of wavelength and is a minimum near the center wavelength of the exciton transitions. For the structure described in the Example given below, the projected value at the peak of the curve is approximately dₘᵢₙ=2.9×10⁻⁶ Å (W/Hz)^{½}. We have extended this same calculation to a structure with 30% aluminum barriers, for which we find dₘᵢₙ=5.5×10⁻⁷ Å (W/Hz)^{½}. This value is substantially better than the value for a confocal Fabry-Perot interferometer in transmission, but with a broader bandwidth and without the requirement for length stabilization.

We have found several advantages when using a polymer composite as a bulk photorefractive, holographic beamsplitter element in such an interferometer. First, a polymer composite allows for large coupling coefficients at practical values of the applied electrical field Eₒ. Further, an applied field alters the spatial phase of the index grating in the polymer composite which allows coherent detection in the linear regime. As another advantage, the device absorption under typical operating conditions can be low.

As has been discussed by P. Delaye, et al., in the Proc. SPIE (1996) v. 2782, at p. 464, et seq., the importance of the sensitivity as a figure of merit can be seen by first considering the detection process for an ideal, plane-wave homodyne interferometer in the shot noise limit. In such a case, the signal-to-noise ratio is given by the following equation:

$$\frac{S}{N} = ( \sqrt{\frac{2 η P}{hv ( BW )}} ) Δ , \qquad ( 12 )$$

where η is the detector quantum efficiency, P is the signal beam power at the entrance to the detector, h is Planck's constant, v is the optical frequency, BW is the electronic bandwidth and Δ is the rms phase excursion in radians. If the phase excursion results from the interrogation of a vibrating surface at normal incidence, then Δ=(4π/λ)d, where λ is the optical wavelength and d is the rms surface displacement amplitude. In this case, Equation 12 becomes:

$$\frac{S}{N} = ( \sqrt{\frac{2 η P}{hv ( BW )}} ) ( \frac{4 π}{λ} ) d . \qquad ( 13 )$$

For an ideal homodyne interferometer, an expression for the minimum detectable surface displacement is derived from Equation 13 to be:

$${d}_{lim}^{ideal} = ( \frac{λ}{4 π} ) \sqrt{\frac{hv}{2 η}} \qquad ( 14 )$$

We find at this limit, that dₗᵢₘ^{ideal}=2.7×10⁻⁷ Å (W/HZ)^{½} at a wavelength of 670 nm, with η=0.63. By comparison, the sensitivity for a confocal Fabry-Perot (“CFP”) in transmission is approximately 3×10⁻⁶ Å (W/Hz)^{½}, that is, the CFP is approximately ten times less sensitive than the ideal homodyne limit.

We define above an amplitude coupling coefficient γ. This parameter is used in the wave equations which determine the distribution of amplitude and phase between the two beams 20, 32, and is introduced as an exponential propagation factor (γz). The coupling coefficient is complex and is thus written as γ=γ_{R}+iγ_{I}. For a pure index grating, the real part of γ gives rise to energy transfer, while the imaginary part of γ gives rise to phase coupling. The magnitude of γ is determined by the space charge field and the electro-optic response. The spatial phase of γ is determined by the charge transport mechanism. When γ is purely imaginary (γ=γ_{I}), the grating spatial phase is 0° and we have the ideal condition for linear detection. Even where there is a contribution from the real part of γ and the phase is not 0°, the linear signal still dominates as long as γ_{I} does not equal zero.

With these definitions, the signal-to-noise ratio in the shot-noise limit for a homodyne receiver based on two-wave mixing is given by:

$$\frac{S}{N} = \sqrt{\frac{2 η P}{hv ( BW )}} ( \frac{4 π}{λ} ) exp ( - \frac{α L}{2} ) sin ( {γ}_{I} L ) d , \qquad ( 15 )$$

where α is the power absorption coefficient and L is the sample thickness. In such a case, the noise-equivalent surface displacement amplitude is:

$${d}_{lim} = \frac{λ}{4 π} \sqrt{\frac{hv}{2 η}} [ exp ( \frac{α L}{2} ) / sin ( {γ}_{I} L ) ] . \qquad ( 16 )$$

The term in brackets in Equation 16 contains all material-related parameters. By comparison with Equation 14, it can be seen that we can approach the classical homodyne limit for low absorption and for γ_{I}L approaching or approximating π/2. It has been calculated by P. Delaye, et al., Proc. SPIE (1996),v. 2782, p.464 et seq., that sensitivity values within a factor of two of the classical limit can be obtained where α/γ_{I} is less than or equal to 0.5. For this limit, a favorable and tolerant condition exists for photorefractive polymer composites characterized by values of α/γ_{I} on the order of 0.01 at 676 nm for an applied field of 60 V/μm. At shorter wavelengths, the absorption coefficient rises rapidly, yielding faster response times. Even at shorter wavelengths, a considerable increase in the absorption coefficient (a) can be tolerated without violating the condition α/γ_{I}<0.5.

By selecting different constituent materials of the polymer composite, it is possible to optimize several physical properties for photo-refractivity, such as, for example, photosensitivity, photo-conductivity and electro-optic response. By selection of the constituent materials, suitable polymer composites can be made with lower costs and quick synthesis, and can be easily processed into a variety of different shapes and forms.

Referring again to FIG. 1 of the drawings, a homodyne, reference beam interferometer 10 includes, as in the preferred embodiment, a laser generator 12 which generates as its output a polarized, coherent light beam 14 directed by mirror 16 to a beamsplitter 18. The beamsplitter 18 divides the beam 14 to create a reference beam 20 and a probe beam 24. The reference beam 20 passes through the beamsplitter 18 to be directed by mirror 22 toward the holographic element 36. The probe beam 24 is directed by the beamsplitter 18 as beam 24 to the workpiece 26, at its surface 28. Surface 28 is normally rough so that the reflected beam 32 from or off of it is speckled and will have spatial wavefront distortions. Again, the workpiece 28 is vibrated at ultrasonic frequencies by pulsed laser 30 impinging the workpiece through its output beam 31, as explained above. The vibration of the workpiece surface 28 will impart a phase perturbation on the speckled reflection signal beam 32. The beams 30, 32 are directed or guided, as explained above, as is normally done by mirrors or lenses to the holographic element 36, resulting in two output beams 40, 44, one of which will be guided toward and detected by detector 46, all as will be explained in greater detail below.

The signal beam 32 and the reference beam 20 will be diffracted in the holographic element 36 with a result similar to that shown in FIG. 2. The signal beam 32, having the distortions 33 will pass through the holographic element 36 with part of the beam 32′ being passed directly as a component part 32′ of beam 40, having the distortion in its wavefront 41. Part of the signal beam 32 will be diffracted as component part 32″ of beam 44 having planar wavefronts 45. Similarly, the reference beam 20 will have part of its beam passed directly through the holographic element 36 resulting as a component part 20″ of beam 44 having its composite wavefront 45 planar. Part of the reference beam 20 will be diffracted and become a component part 20′ of the beam 40 having the distortions in its wavefront 41.

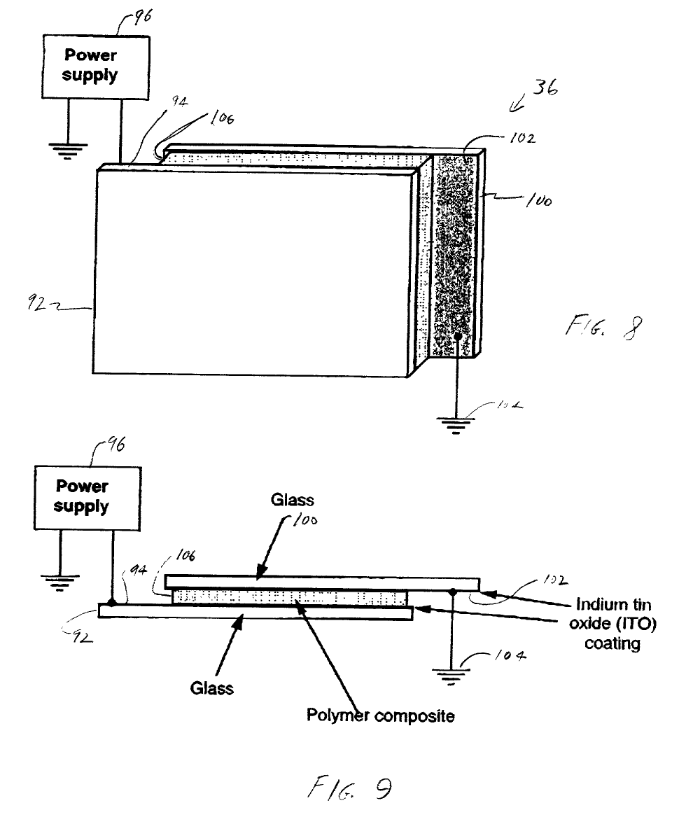

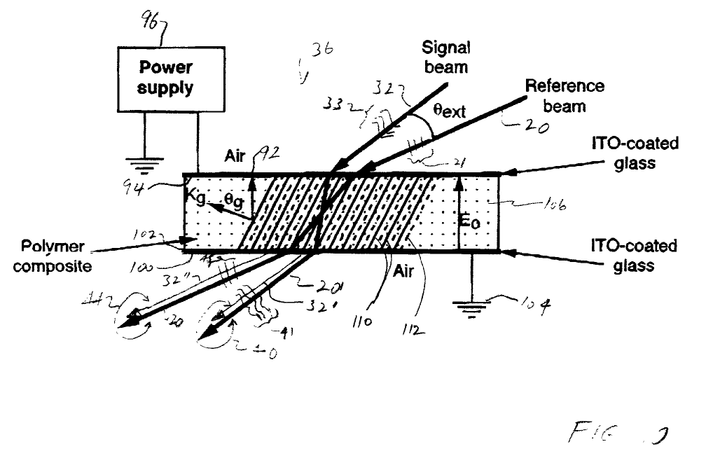

As better seen in the perspective view of FIG. 8 and the plan view of FIG. 9, the holographic element 36 comprises a “sandwich” having a receiving surface 92 comprised of a glass or another transparent window material having a small thickness and coated on the inside with indium-tin-oxide (ITO) 94 or another substantially transparent electrically conductive layer. The inside surface coated with the ITO is electrically connected to a direct current voltage source power supply to establish a potential difference across the sandwich. Spaced a small distance from the receiving surface 92 is exit plane or exit surface 100, comprising also a glass window having a small thickness and having its inside surface comprising an ITO coating 102. The ITO coating surface 102 of the exit glass 100 is electrically connected to ground 104, so that the power supply 96 can establish a potential between these glasses 92, 100 and their interior facing surfaces 94, 102. Between these glass surfaces 92, 100 is a polymer composite 106 according to the principles of this invention. A polymer composite suitable for the practice of this invention is PVK:7-PDCST:BBP:C₆₀.

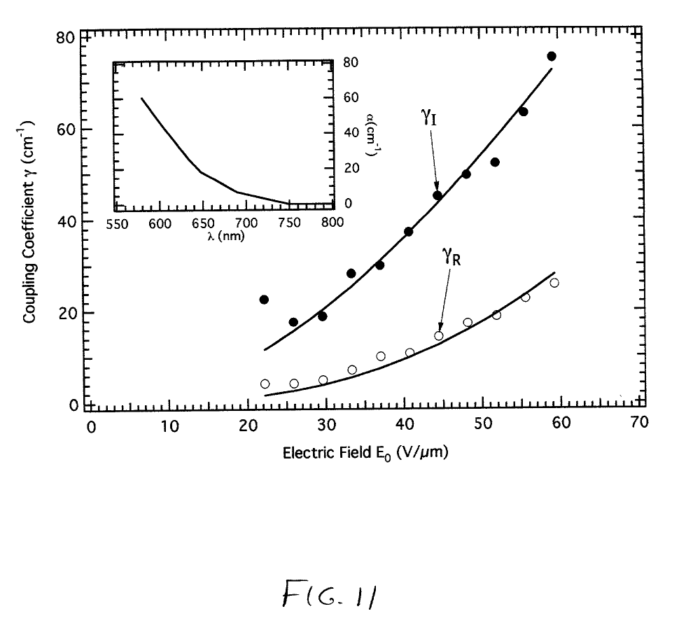

FIG. 10, a cut-away view of the holographic element, schematically shows the passage of the reference and signal beams through the element 36, where like reference numerals indicate the same beams and beam confgurations as shown in FIGS. 1 and 2. The beams 20, 32 interfere in the polymer composite 106 thereby producing an intensity grating 110. This intensity grating 110 writes or establishes a diffraction grating 112. When an electrical voltage is applied from the power supply or voltage source 96, an electrical field Eₒ is established across the polymer composite 106, enhancing the diffraction gratings 112. The electrical field Eₒ enhances the amplitude of the coupling coefficient and also controls its phase.

To demonstrate the utility of a photorefractive polymer composite for adaptive interferometry, two experiments were performed. We set forth below the conditions, parameters and results of these experiments by way of example in order to further describe our invention:

### EXAMPLE I

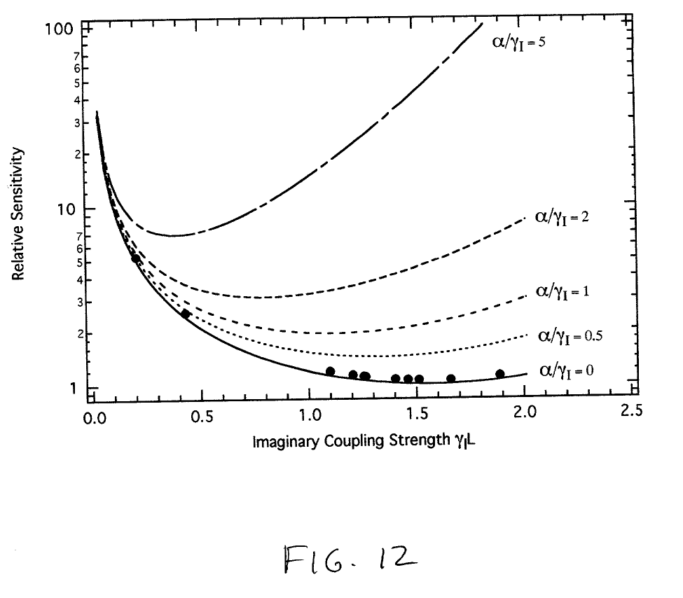

Polymer components consisting of (i) the charge-transporting network poly(n-vinyl carbazole) (PVK), (ii) a derivative of the nonlinear optical chromophore 4-piperidinobenzylidenemalononitrile (PDCST), (iii) the fullerene C₆₀, and (iv) the liquid plasticizer butyl benzyl phthalate (“BBP”), were dissolved in the ratio 49.5:35:15:0.5 percent by weight in a four to one by volume solvent mixture of toluene and cyclohexanone. The mixture was subsequently dripped onto indium tin oxide (ITO) coated glass plates at a temperature of 45° Centigrade and left to dry overnight in an oven maintained at 130° Centigrade. The plates were assembled at 150° Centigrade with mylar spacers, yielding a sample of thickness (L) equaling 135 micrometers (μm). The wavelength dependence of the power absorption coefficient (α) is shown in the inset of the plot depicted in FIG. 11, where α=9 per centimeter (cm⁻¹) at the operating wavelength of 676 nanometers (nm). The refractive index (n) was measured to be n=1.63. The glass transition temperature was measured, using a modulated differential scanning calorimeter, and found to be 28° Centigrade. The material is, therefore, classed as a low glass-transition temperature material. Accordingly, coarse temperature stabilization was used to avoid heating to the glass-transition temperature. In this first experiment, the amplitude gain coefficient as a function of the applied electric field was measured in a series of two-wave mixing runs using the structure shown in FIGS. 1, 2, 8 and 9. Each measurement comprised two stages. In the first stage, two p-polarized beams of equal intensity were overlapped inside the composite polymer configured in the configuration of FIG. 8. The steady-state amplification (g₁) of the signal beam 32 was measured as g₁=I₁(with pump)/I₁(without pump) in order to account for optical absorption in the polymer composite 106. The measured amplification and the known thickness were used to determine the real part of the coupling coefficient (γ_{R}). During the second stage, the interference pattern was translated at a constant rate much faster than the response speed of the polymer composite material 106. The resulting homodyne mixing leads to sinusoidal oscillations in the output intensities of the two beams 20, 32. The steady-state phase shift of the grating was calculated from the steady-state amplification of the signal beam 32 (g₁) and the amplitude of the oscillation of the beam 32. The imaginary component of γ can be calculated from the real component of γ and the steady state phase shift. In our experiment, the phase shift measurement only carried out for the s-polarized light which experiences a much smaller gain coefficient than p-polarized light, in order to reduce the complications associated with phase shift analysis in the presence of large energy- and phase-coupling. The experimental results are plotted in FIG. 11. The solid lines are fits using the theoretical expression for the coupling coefficient. In the usual case where Eₒ is much less than E_{q}, where E_{q} is the trap-limited field, the imaginary part of coupling coefficient (γ_{I}) is proportional to the square of the applied voltage Eₒ, and the ratio of the real part of the coupling coefficient γ_{R} to the imaginary part of the coupling coefficient γ_{I} is approximately equal to the ratio of Eₒ to E_{q}. In this example, the trap densities of the photorefractive polymer composite are large, on the order of 10¹⁷ cm⁻³. It is believed that these trap densities, combined with the small dielectric constant, result in the large values for E_{q} that we have observed, up to 90 V/μm. It is believed that these large values for E_{q} combine with the large electro-optic response from the orientational enhancement effect to produce the large gain coefficients observed.

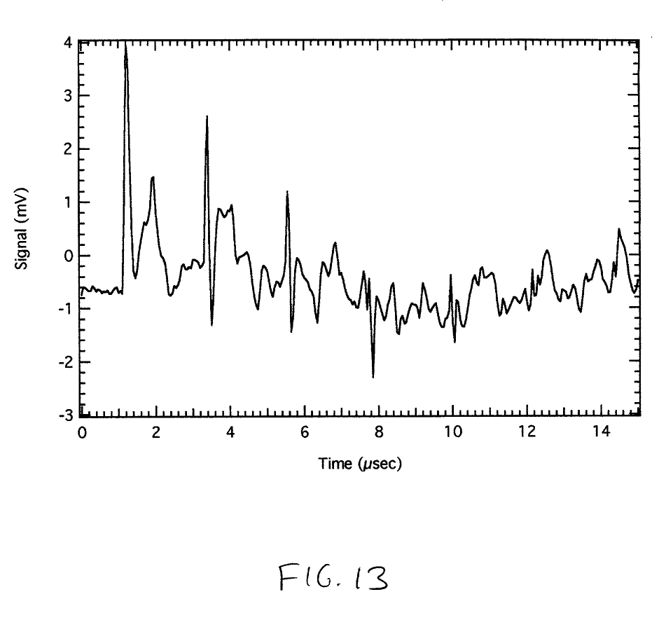

In FIG. 12, we show the plot of our calculated values of the surface displacement sensitivity dₗᵢₘ normalized to the ideal homodyne detection limit dₗᵢₘ^{ideal} of Equation 14 above. This relative detecting limit is equal to the factor in brackets in Equation 16 above. This bracketed expression contains all material dependent quantities. Its ideal value is unity. The solid circles or dots of FIG. 12 were determined from the data plotted in FIG. 11 for Eₒ= 60 V/μm and λ=676 nm. The independent variable was the thickness L. At these selected values of Eₒ and λ, the potential performance of the photorefractive polymer composite beam holographic element 36 at the optimum thickness of L=0.22 mm is only twenty percent higher than the classical detection limit.

To measure the surface displacement sensitivity of the polymer composite described above in Example I, an experiment was performed, the results of which we set forth by way of example in order to further describe our invention:

### EXAMPLE II

A two-wave mixing receiver as schematically described in FIG. 1 was used, with the exception that a flat mirror was used to simulate a workpiece, and an electro-optic phase modulator was inserted in the reference beam. The photorefractive polymer composite was the same as used in Example I above. The power of the reference light beam 20 was selected at thirty-eight (38) times the power in the signal beam 32. The detector was a New Focus model 1801 silicon photodiode with integrated amplifier having a bandwidth of 125 MHz. The actual signal bandwidth was set or preselected by the digital oscilloscope to be 30 MHz. A separate calibration of the modulator showed the peak-to-peak phase excursion at 10 volts peak-to-peak drive, to be 0.22 radians. From observations with a spectrum analyzer, the signal-to-noise ratio was found to be one, S/N=1, for a peak-to-peak modulator drive of 0.2 volts peak-to-peak. For this drive voltage, the phase excursion was calculated to be 4.4×10⁻³ radians peak-to-peak, or 1.6×10⁻³ radians root mean square (“rms”). For a wavelength (λ) of 676 nm, the equivalent surface displacement (d) was 0.083 nm rms. The signal power on the photodetector 46 was measured to be 23 microwatts (μW). Using this value for power, and having an oscilloscope bandwidth of 30 MHz, a surface displacement sensitivity (dₗᵢₘ) of 7.2×10⁻⁸ nm (W/Hz)^{½—} was determined. This value demonstrates an homodyne detection system having a sensitivity that is within a factor of three of the classical limit for an ideal homodyne system.

We have also used this homodyne receiver to detect ultrasonic wave produced by a five Megahertz wideband piezoelectric transducer bonded to a quartz mirror. We set forth by way of example this experiment in order to further describe our invention:

### EXAMPLE III

This experiment was performed using the homodyne receiver system as used in Examples I and II, above, having the arrangement shown in FIGS. 1, 2, 8 and 9. The workpiece in this case was a fused quartz mirror which was energized by a 5 MHz wideband piezoelectric transducer bonded to its rear surface. The transducer had high damping, and produced a single ultrasonic pulse. The ultrasonic wave was recorded using a probe beam from a 15 mW laser diode at 690 nm. The resulting signal beam was mixed in the polymer composite sample described in Examples I and II above. The output signal detected at the photo-detector 46 is shown in FIG. 13. In FIG. 13, the transmitted signal can be readily identified, and its various echoes distinguished.

It may be appreciated that the data of these experiments demonstrate the feasibility of the photorefractive polymer composite ultrasound receiver to remotely detect surface displacements with good signal-to-noise ratios.

It may be seen by the foregoing experiments and examples that the trap density and the grating phase can be controlled. Further, it may be appreciated that the relatively higher resistance characteristic of the polymer composite results in less current, less power dissipation and therefore less heating. By controlling the trap density, the coupling coefficient can be controlled so that we can approach the optimum or classical homodyne limit of approximately γ_{I}L≈π/2.

The foregoing detailed description of our invention and of preferred embodiments as to products, compositions and processes, is illustrative of specific embodiments only. It is to be understood, however, that additional embodiments may be perceived by those skilled in the art. For example, while the present invention has been described with reference to the composite polymer as illustrated in FIGS. 8 and 9, the composition of the polymer composite may be varied to suit design choices and considerations. For example, all or some of the molecular functionalities providing photorefractive behavior to the material could be attached covalently to the polymer. The ability to control the phase and to achieve the desired design features can to some extent be accomplished with such more simple design structures. Accordingly, it is to be understood that the scope of my invention is to be limited solely by the following appended claims.

I claim:

1. A method for detecting sonic vibrations in a test material having a test surface comprising:
a. generating a coherent beam of light having a wavelength;
b. splitting said coherent beam into a first beam and a second beam;
c. first directing said first beam onto said test surface to be scattered by said test surface to result in said scattered first beam having a first phase perturbation;
d. second, directing at least a portion of said scattered first beam and said second beam on a photorefractive polymer composite adaptive beam splitter, wherein said first and said second beams are made co-propagating and with superposed wavefronts; and,
e. third, directing said co-propagating superposed first and second beams onto a photodetector to result in an electrical output signal that is representative of the vibrating test surface.

2. The method of claim 1 wherein said second directing step, the further step of producing an electrical output signal that is linearly proportional to said first phase shift introduced onto said first beam.

3. The method of claim 1 wherein in said second directing step, the further steps of forming of a diffraction grating in the photorefractive polymer composite adaptive beam splitter, and of producing a predetermined phase difference between said first beam and said second beam.

4. The method of claim 3 wherein in said step of producing a predetermined phase difference, said predetermined phase difference is established by applying an electrical field across said photorefractive polymer composite adaptive beam splitter.

5. The method of claim 3 wherein said phase shift produced by said grating is substantially different from zero and substantially different from 180 degrees.

6. The method of claim 5 wherein said phase shift is approximately 90 degrees.

7. The method of claim 1 wherein said generated coherent light beam is a polarized light beam, and wherein said first and said second beams are co-propagating and co-polarized after said second directing step directing said first and said second beams onto said photorefractive polymer composite adaptive beam splitter.

8. The method of claim 1 wherein said sonic vibrations are small vibrational surface deflections.

9. The method of claim 8 wherein said sonic vibrations are on the order of ultrasonic surface vibrations.

10. The method of claim 9 wherein said sonic vibrations are in the range of from one megahertz to fifty megahertz.

11. An apparatus for sensing sonic vibrations on a material having a test surface, comprising:
a. light generating means for generating a coherent, co-polarized beam of light having a predetermined wavelength;
b. beam splitting means for receiving said generated light beam, splitting said generated light beam into at least a first light beam and a second light beam, and for directing said first light beam onto a test material test surface capable of at least scattering said first beam;
c. photorefractive polymer composite adaptive beam splitter means having a photorefractive polymer composite structure including a receiving surface for receiving at least a portion of said scattered first light beam at a first angle relative to said photorefractive polymer composite receiving surface, and for receiving said second light beam at a second angle relative to said photorefractive polymer composite receiving surface which second angle is different from said first angle, for interfering said first and said second beams to introduce a phase shift difference between said first and said second beams, and for producing at least one set of co-propagating light waves comprising at least a portion of said first beam and at least a portion of said second beam received by said photorefractive polymer composite receiving surface; and,
d. photodetector means positioned to receive said one set of co-propagated light beams from said photorefractive polymer composite adaptive beam splitter means, for producing an electrical output signal that is representative of the vibrating test surface.

12. The apparatus for sensing sonic vibrations on a material test surface of claim 11 wherein said photorefractive polymer composite adaptive beam splitter means comprises electrical field means for establishing across said photorefractive polymer composite structure a controllably variable electrical field for predetermining the phase difference between said first and said second beams.

13. The apparatus for sensing sonic vibrations on a test surface of claim 11 wherein said means for producing a phase shift produces a phase shift substantially different from zero and substantially different from 180 degrees.

14. The apparatus for sensing sonic vibrations on a test surface of claim 13 wherein said means for producing a phase shift produces a phase shift of approximately 90 degrees.

15. The apparatus for sensing sonic vibrations on a test surface of claim 11 wherein said generating means includes means for generating a polarized light beam, and wherein said photorefractive polymer composite adaptive beam splitter means includes means for co-propagating said first and said second beams in a co-polarized state.

16. The apparatus for sensing sonic vibrations on a test surface of claim 11 wherein said photodetector means includes means for producing an output signal representative of ultrasonic vibrations of said vibrating test surface.

17. The apparatus for sensing sonic vibrations on a test surface of claim 11 wherein said photodetector means includes means for producing an output signal representative of vibrations of said vibrating test surface in the range of from one megahertz to fifty megahertz.

18. The apparatus for sensing sonic vibrations on a test surface of claim 11 wherein said first light beam comprises a phase perturbation resulting from being directed onto said test surface, and wherein said photodetector means comprises means for producing an output signal that is linearly proportional to said phase perturbation of said first light beam.
